(19) United States
(12) Patent Application Publication
(10) Pub. No.: US 2008/0244198 A1
(43) Pub. Date: Oct. 2, 2008

(54) MICROPROCESSOR DESIGNING PROGRAM, MICROPOROCESSOR DESIGNING APPARATUS, AND MICROPROCESSOR

(75) Inventor: Hiroki GOKO, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/042,550

(22) Filed: Mar. 5, 2008

(30) Foreign Application Priority Data
Mar. 27, 2007 (JP) 2007-081469

(51) Int. Cl. G06F 12/00

(52) U.S. Cl. 711/154; 711/E12.001

(57) ABSTRACT

A microprocessor which can be operated with small power consumption, a microprocessor designing program which can design it in a short period of time, and a microprocessor designing apparatus. The microprocessor designing program comprises an execution program storing step of storing each of the execution programs in said specified address areas, in correspondence with the specification of said address areas made for each of the execution programs, an access number totalizing step of counting a total number of accesses given by the computation processing unit for each of the address areas, and an execution program name outputting step of outputting an execution program name outputted in an order based on said total number. The microprocessor designing apparatus packages a microprocessor designing program, and comprises an execution program name displaying component displaying, in characters, the name of an execution program outputted by the execution program name displaying step.

### BACKGROUND OF THE INVENTION

1. Field of the Invention

The present invention relates to a microprocessor, a microprocessor designing program for designing the microprocessor, and a microprocessor designing apparatus.

2. Description of the Related Art

Recently there have been proposed the designing environment, designing systems, designing support programs or designing support apparatuses which have an object of designing, at a short period of time, microprocessors best fitted to the applications. These have mainly an object of enhancing the computing performance of the microprocessor, such as high-speed computation by removing redundant processing and unnecessary facility and the like, detection and correction of computation processing program failures. For example, Japanese Patent Kokai No. 2003-202993 (Patent Document 1) discloses a system, a method and a program which have an object of enhancing the computation processing performance by having two processing instruction execution sections which enables a microprocessor to execute a byte code instruction, where a byte code instruction with high frequency of execution is processed by a first processing instruction execution section, and a byte code instruction with relatively low frequency of execution is processed by a second instruction execution section.

Incidentally, aside from enhancement of the microprocessor computing performance, reduction of power consumption of the microprocessor is demanded. The microprocessor consumes power to perform computation and to access a memory. Ordinarily, as the power consumption of the microprocessor becomes more, the calorific value and the amount of power supply noise increase. As a counter-measure against them, there arises a problem that it is required to enlarge a cooling device, or to increase the number of capacitors to be placed around the microprocessor. Also to avoid these problems, it is important to reduce the power used by the microprocessor.

However, for example, as a system disclosed in Patent Document 1, most of the conventional art places stress on performance enhancement of computation processing. On the other hand, it can be considered to reduce power consumption by making the computation processing more efficient. As a means of making the computation processing more efficient, for example, deletion of redundancy processing or unnecessary facility can be enumerated. However, it takes much time to perform them actually. Further, effect of the efficiency promotion by these means is restricted, and reduction of power consumption by efficiency promotion of computing processing has limitations.

### SUMMARY OF THE INVENTION

In view of the foregoing problems, it is an object of the present invention to provide a microprocessor which can be operated with low power consumption, a microprocessor designing program which can design it at a short period of time, and a microprocessor designing apparatus.

A microprocessor designing program according to the present invention is a microprocessor designing program for designing a microprocessor which comprises a memory composed of a plurality of address areas, and a computation processing unit which executes an instruction of an execution program which is stored in the address area accessed to any of said address areas, wherein comprised are an execution program storing step which stores each of said execution programs in correspondence with the specification of the address area made for each of said execution programs, an access number totalizing step where the computation processing unit counts the total number of accesses, and an execution program name outputting step which outputs the execution program name in the order according to said total number.

A microprocessor designing apparatus according to the present invention, wherein packed is a microprocessor program according to the present invention, and comprised is an execution program name displaying means for displaying, in characters, an execution program outputted by said execution program name outputting step.

The microprocessor according to the present invention, wherein each of the execution programs stored in each of the address areas having a large total number of accesses is accumulated in each of the address areas adjacent or consecutive to each other in said memory.

### BRIEF DESCRIPTION OF THE DRAWINGS

FIG. 1 is a block diagram showing an external program memory and an external data memory at the same time, as an example of microprocessor configuration;

FIG. 2 is a diagram showing an example of a memory area where an execution program is stored;

FIG. 3 is a flow chart showing an example of a processing routine of the microprocessor designing program;

FIG. 4 is a flow chart showing an example of a microprocessor designing flow according to the microprocessor program;

FIG. 5 is a diagram showing a display example of the execution program names;

FIG. 6 is a diagram showing an example of a memory area when an execution program is restored;

FIG. 7 is a diagram showing an example of a hardware information database of the internal program memory;

FIG. 8 is a diagram showing an example of a memory configuration which is outputted by a microprocessor designing program based on the hardware information database; and

FIG. 9 is a flow chart showing an example of a microprocessor designing flow including the output processing of the memory configuration.

### DETAILED DESCRIPTION OF THE INVENTION

Embodiments of the present invention will be described in detail with reference to the accompanying drawings.

A microprocessor designing apparatus according to the present invention includes ordinary elements of a computer system such a processor, a program memory, a data memory, memory controller, a keyboard, a display for displaying characters and/or images, I/O ports, and so on mutually connected via buses, like conventional microprocessor designing apparatuses.

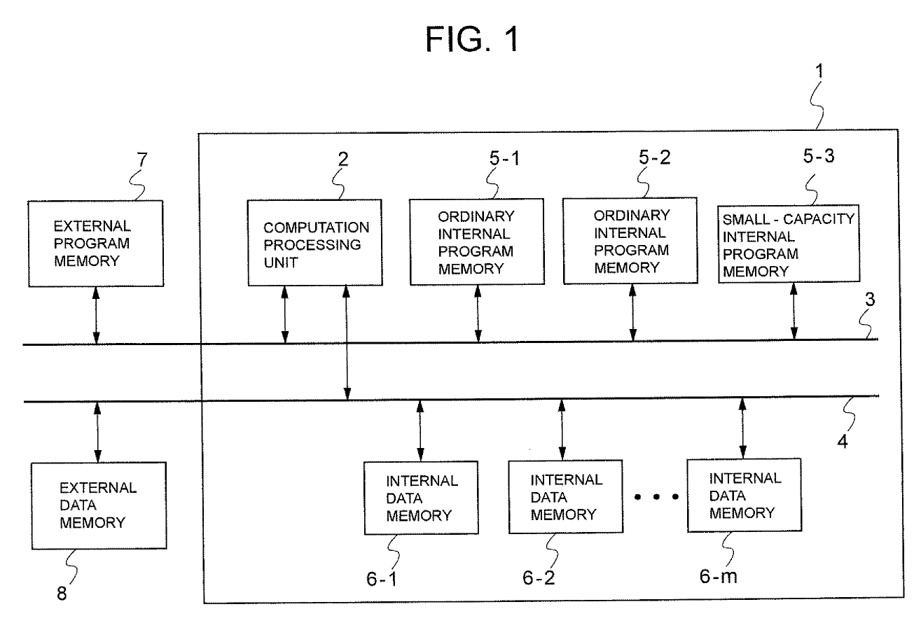

FIG. 1 is a block diagram showing an exemplary configuration of the microprocessor 1, together with the external program memory 7 and external data memory 8.

The microprocessor 1 comprises a computation processing unit 2, a program bus 3, a data bus 4, ordinary internal program memories 5-1 and 5-2, a small-capacity internal program memory 5-3, and internal data memories 6-1 to 6-m (where m is a positive integer).

The computation processing unit 2 has facilities of accessing the internal program memories 5-1 and 5-2, the small-capacity internal program memory 5-3, the internal data memories 6-1 to 6-m, the external program memory 7, and the external data memory 8, and of executing the execution programs stored in them. Through the program bus 3, the computation processing unit 2 accesses the ordinary internal program memories 5-1 and 5-2, the small-capacity internal program memory 5-3 and the external program memory 7. Further, through the data bus 4 the computation processing unit 2 accesses the internal data memories 6-1 to 6-m, and the external data memory 8.

The internal program memories 5-1 and 5-2, the small-capacity internal program memory 5-3 and the external program memory 7 respectively store an execution program which is executed by the microprocessor 1. The execution program in this context is, for example, a program which is made by compiling source codes described by C or C++ language. Also, this execution program can perform, for example, the facility of a filter computing function. The ordinary internal program memories 5-1 and 5-2 are internal memories for program, which have a normal size capacity. On the other hand, the small-capacity internal program memory 5-3 is an internal program memory having a smaller capacity than the internal program memories 5-1 and 5-2. In the drawing, this memory is expressed in a size smaller than the ordinary internal program memories 5-1 and 5-2. These memories are different in capacity, for example: the programming ordinary internal memory 5-1 has a capacity of 50 KB, the programming ordinary internal memory 5-2 has a capacity of 40 KB, and the small-capacity internal program memory 5-3 has a capacity of 10 KB. Specifically, in this embodiment, provided are two ordinary internal program memories and one small-capacity internal program memory. However, the present invention has no limitation in respect to the number of the ordinary internal program memories and small-capacity internal program memories.

The internal data memories 6-1 to 6-m, and the external data memory 8 respectively store data to refer to, when the microprocessor 1 executes a program. The data in this context is, for example, an initial value or a constant which are used in a program.

The external program memory 7 is a memory packaged outside of the microprocessor 1. Ordinarily, execution programs which are executed at a low frequency of execution are stored in the external program memory 7. The external data memory 8 is a memory packaged outside of the microprocessor 1. Ordinarily, in the external data memory 8, data such as initial value and constant, which has a low frequency of access, are stored.

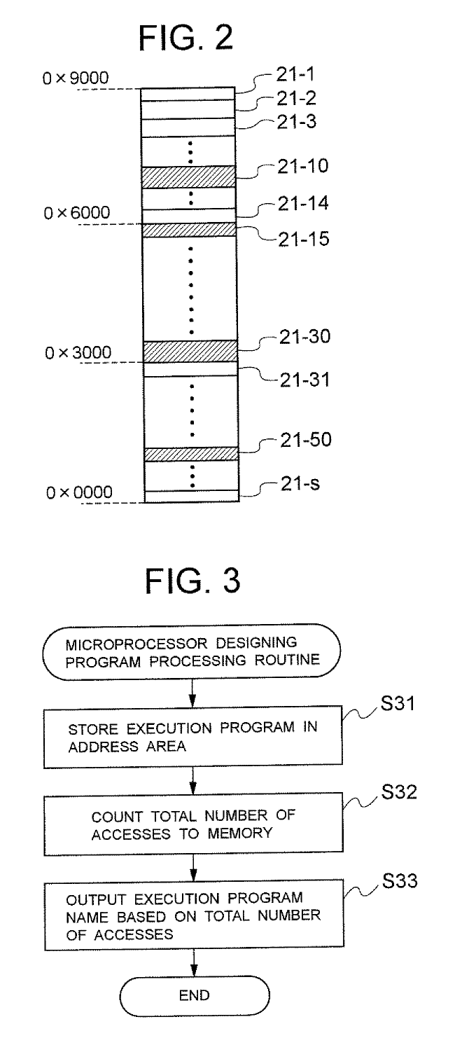

FIG. 2 shows an example of the memory area for storing the execution program. In this event, a memory address is supposed to be 0×0000-0×9000.

Ordinarily, the memory area for storing the execution program is composed of a plurality of the address areas 21-1 to 21-s (where “s” is a positive integer). The address areas 21-1 to 21-s may not be same respectively in size. Ordinarily, in each of the address areas 21-1 to 21-s, the execution programs are stored. For example, in the address area 21-10, the filter computing function is stored, and in the address area 21-15, a loop processing function is stored. Ordinarily, the facility realized by the execution programs which are stored in each of the address areas 21-1 to 21-s is different with each other.

Specifically, the memory area in the figure is a virtual memory area in the computer, where the microprocessor program is executed in correspondence with a memory area as hardware finally packaged.

FIG. 3 is a flow chart showing an example of the processing routine of the microprocessor designing program.

The microprocessor designing program comprises an execution program storing step (S31), an access frequency totalizing step (S32), an execution program name outputting step (S33), and execution of the execution program storing step (S31), and the access frequency totalizing step (S33) enables the microprocessor designing apparatus to function, as an execution program storing step, an access frequency totalizing step, and an execution program name outputting step, respectively.

The execution program storing step stores each of the execution programs in said specified address areas in correspondence with the specification of the address areas made for each of the execution programs. The designer of the microprocessor 1 specifies an address area for each execution program. For example, an address area is specified by using an inputting apparatus (not shown) and the like, attached to an apparatus which packages the microprocessor designing program. For example, as shown in FIG. 2, stored are a filter computing function in the address area 21-10 of the memory areas, a loop processing function and the like in the address area 21-15, and an execution program in each of the address areas 21-1 to 21-s, respectively.

The access frequency totalizing step counts a total number of accesses which the computation processing unit 2 makes to each of the address areas. Further, the access frequency totalizing step ordinarily counts the total number of accesses which the execution program stored in a virtual memory area makes in correspondence with the execution programs stored in the internal program memories 5-1 to 5-3. Also, the total number of the accesses may be counted while the computation processing unit 2 executes the execution program, accessing the address area. For each of the address areas, ordinarily stored are the execution programs for realizing the facilities different with each other. As the respective execution programs are different in facility to realize, ordinarily the number of accesses of the computation processing unit 2 is different in each of the address area. For example, when the computation processing unit 2 has a high frequency of using the filter computing function, the computation processing unit 2 makes an increased total number of accesses to the address areas 21-10 (hereinafter called “total number of accesses”) where the filter computing function is stored.

The execution program name outputting step outputs an execution program name in an order based on a total number of accesses. The execution program name is stored previously in the microprocessor designing apparatus and/or the microprocessor 1. The execution program name outputting step outputs, for example, an execution program name stored in the address area in the descending order of the total number of accesses. Further, the apparatus which packages the microprocessor designing program comprises an execution program name displaying step for displaying, in characters, a name of the execution program outputted by the execution program outputting step. As the execution program name is displayed in characters, the designer of the microprocessor 1 can confirm by the display of the microprocessor designing apparatus the execution program name stored in the address area, for example, in the descending order of the total number of accesses.

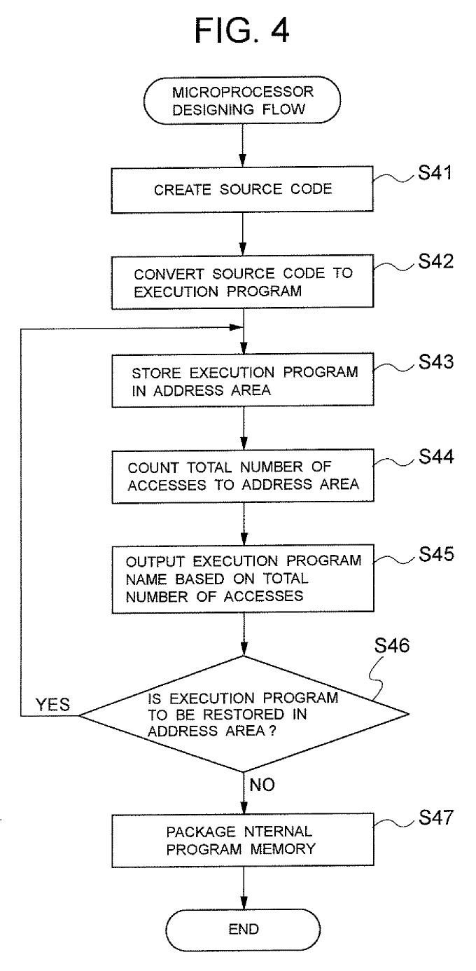

FIG. 4 is a flow chart showing an exemplary designing flow of the microprocessor 1 according to the microprocessor designing program. Referring to FIG. 4, the designing flow of the microprocessor 1 will be described.

First, the designer of the microprocessor 1 creates source codes of the microprocessor 1 with a programming language such as C and C++ (S41). Next, the source code is converted to an execution program with a general compiling step (S42). Next, the designer of the microprocessor 1 specifies an address area for each of the execution programs.

The execution program storing step of the microprocessor designing program stores each of the execution programs in a specified address area (S43). Different execution programs are stored in each of the address areas 21-1 to 21-n. Here, as an example, an assumption is made that stored are a filter computing function in the address area 21-10, a loop processing function in the address area 21-15, an integrating function in the address area 21-30, and a string processing function in the address 21-50.

The access frequency totalizing step of the microprocessor designing program determines the total number of accesses which the execution program makes to each of the address areas 21-1 to 21-n. The total number of the accesses which the computation processing unit 2 makes to each of the address areas is counted while the computation processing unit 2 executes the execution program, accessing the address areas 21-1 to 21-n (S44). The computation processing unit 2 in this context is supposed to access in total 1000 times to the address area 21-10, 800 times to the address area 21-15, 600 times to the address area 21-30, 500 times to the address area 21-30, and 500 times to the address area 21-50. In all of the address areas 21-1 to 21-n, the top four areas having a large total number of the accesses are supposed to be the address areas 21-10, 21-15, 21-30 and 21-50.

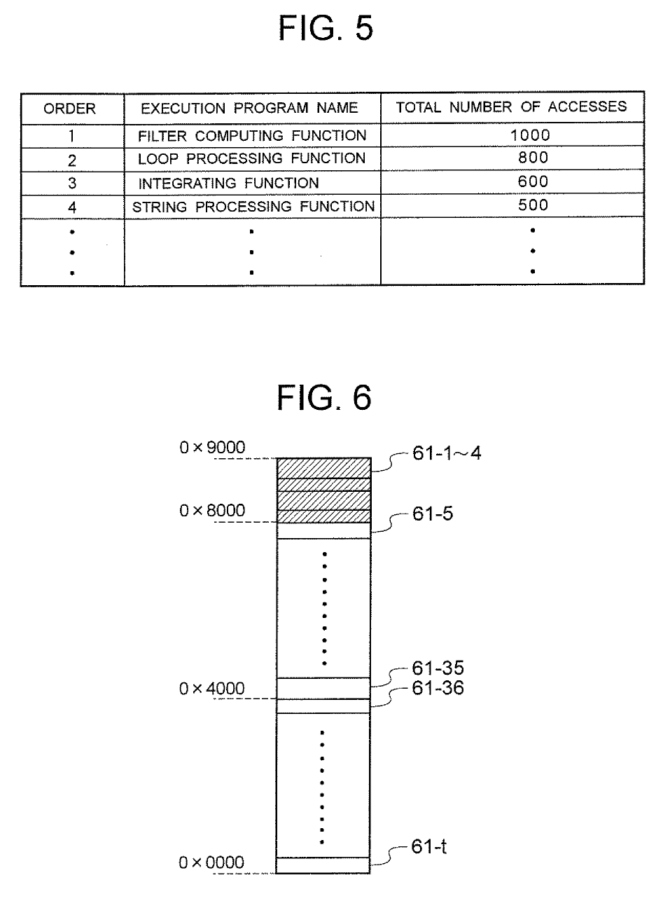

The microprocessor designing program name outputting step outputs an execution program name in an order based on the total number of accesses (S45). Here, the execution program name outputting step sequentially outputs an execution program name which is stored in the address area, in the descending order of the total number of accesses. Further, an apparatus which packages the microprocessor designing program displays the execution program name, in characters, according to the execution program name displaying step. FIG. 5 is a diagram showing a display example of the name of the execution program. The execution program name displaying step in this context displays, as a name of the execution program, in the descending order of the total number of accesses, i.e., in the order of the filter computing function, the loop processing function, integrating function, and the string processing function. FIG. 5 is an example displaying, in characters, the total number of accesses, together with the execution program name. In this event, in addition to the foregoing, the address areas may be simultaneously displayed in characters.

As the execution program name is displayed in characters, the designer of the microprocessor 1 can confirm the execution program name in the descending order of the total number of accesses. According to displayed results, the designer of the microprocessor 1 judges whether the execution program is restored or not in the address area (S46). In this event, ordinarily the address area in which the execution program is restored is a new address area created by dividing again the memory area into a size different from that of the current address areas 21-1 to 21-n.

Currently, the address areas 21-10, 21-15, 21-30, and 21-50, which have a large total number of accesses, as shown in FIG. 2, are dispersed in the memory areas. The designer of the microprocessor 1 makes store intensively each of the execution programs which are stored in each of the address areas having a large total number of accesses, in each of the address areas adjacent or consecutive to the memory areas. Here, the designer is supposed to determine to restore intensively the filter computing function, the loop processing function, the integrating function and the string processing function, respectively stored in the address areas 21-10, 21-15, 21-30 and 21-50 which have a large total number of accesses, in each of the address areas consecutive to part of the memory areas. After correcting the specification of the address areas, the designer of the microprocessor 1 can store again an execution program in a desired address area according to the execution program storing step (S43).

FIG. 6 is a diagram showing an exemplary memory area, when the execution program is restored by the execution program storing step. The memory area in this context is composed of a plurality of the address areas 61-1 to 61-t (where “t” is a positive integer). The execution program storing step in this context is supposed to store respectively the filter computing function in the address area 61-1, the loop processing function in the address area 61-2, the integrating function in the address area 61-3, and the string processing function in the address area 61-4. Specifically, the memory area in the figure is not a memory area as hardware finally implanted, but a virtual memory area in a computer, which executes a microprocessor designing program.

Following the step of restoring these execution programs (S43), counting of the total number of accesses to each of the address areas 61-1 to 61-t (S44), and outputting of the execution program name based on the total number of accesses are performed in the same way. When the designer of the microprocessor 1 judges that it is not necessary to restore the execution program in the address area, the ordinary internal program memories 5-1 and 5-2, and the small-capacity internal program memory 5-3 are packaged in the microprocessor 1 (S47).

For example, as shown in FIG. 2, a memory area is supposed to be divided into three: 0×0000-0×3000, 0×3001-0×6000, and 0×6001-0×9000. In the memory area 0×0000-0×3000, included is the address area 21-31, in the memory area 0×30011-0×6000, included are the address areas 21-15 to 21-30, and in the memory areas 0×6001-0×999, included are the address areas 21-1 to 21-14. Supposed to stored are the execution program which is stored in the address areas 21-31 to 21-s, in the programming ordinary internal memory 5-1, the execution program which is stored in the address areas 21-15 to 21-30, in the programming ordinary internal memory 5-2, and the execution program which is stored in the address areas 21-1 to 21-14, in the small-capacity internal program memory 5-3. In this event, stored are the filter computing function having a large total number of accesses in the small-capacity internal program memory 5-3, the loop processing function and the integrating function in the programming ordinary internal memory 5-2, and the string processing function in the programming ordinary internal memory 5-1, respectively. Therefore, the computation processing unit 2 accesses frequently the ordinary internal program memories 5-1 and 5-2 and the small-capacity internal program memory 5-3. Ordinarily, the more the number of the memories which the computation processing unit 2 accesses frequently is, or the larger the storage capacity of the memory to be accessed is, the more the power consumption of the microprocessor 1 becomes. As described above, when the ordinary internal program memories 5-1 and 5-2, and the small-capacity internal program memory 5-3 are packaged in the microprocessor, the number of the internal memories which the computation processing unit 2 accesses frequently is three, i.e, the internal program memories 5-1 and 5-2, and the small-capacity internal program memory 5-3, and the ordinary internal program memories 5-1 and 5-2 store other execution programs than the above-described four functions, and are larger in storage capacity than the small-capacity internal program memory 5-3, thus resulting in increase of the power consumption of the microprocessor 1.

For example, as shown in FIG. 6, a memory area is supposed to be divided into three: 0×0000-0×4000, 0×4001-0×8000, and 0×8001-0×9000. Included are the address areas 61-36 to 61-t in the memory areas 0×0000-0×4000, the address areas 61-5 to 61-35 in the memory areas 0×4001-0×8000, and in the memory area 0×8001-0×9000, the address areas 61-1 to 61-4 in the memory areas 0×8001-0×9000.

As the small-capacity internal program memory 5-3 shown in FIG. 1 is smaller in capacity than the ordinary internal program memories 5-1 and 5-2, power consumed for accessing data in the small-capacity internal program memory 5-3 is lower than the power consumed for accessing data in the ordinary internal program memories 5-1 and 5-2. For example, when the execution program stored in the address areas 61-1 to 61-4, shown in FIG. 6, is stored in the small-capacity internal program memory 5-3, all of the filter computing function, the loop processing function, the integrating function, and the string processing function which have a large total number of accesses are stored in the small-capacity internal program memory 5-3. In this event, frequent access of the computation processing unit 2 is limited only to the small-capacity internal program memory 5-3, which permits to reduce the power consumption in the totality of the microprocessor 1.

As described above, the designer of the microprocessor 1 can determine the quantity and the storage capacity of the ordinary internal program memories 5-1 and 5-2 and the small-capacity internal program memory 5-3, and then separately store the execution programs in them. On the other hand, the microprocessor designing program can determine and then output the memory configuration including the quantity and storage capacity of the ordinary internal program memories 5-1 and 5-2, and the small-capacity internal program memory 5-3. In this event, the hardware information of the ordinary internal program memories 5-1 and 5-2 and the small-capacity internal program memory 5-3 is prepared to be inputted in the microprocessor designing program. The hardware information in this context includes, for example, storage capacity, packaging area, and power consumption. The inputted hardware information is stored as a database in the microprocessor designing program.

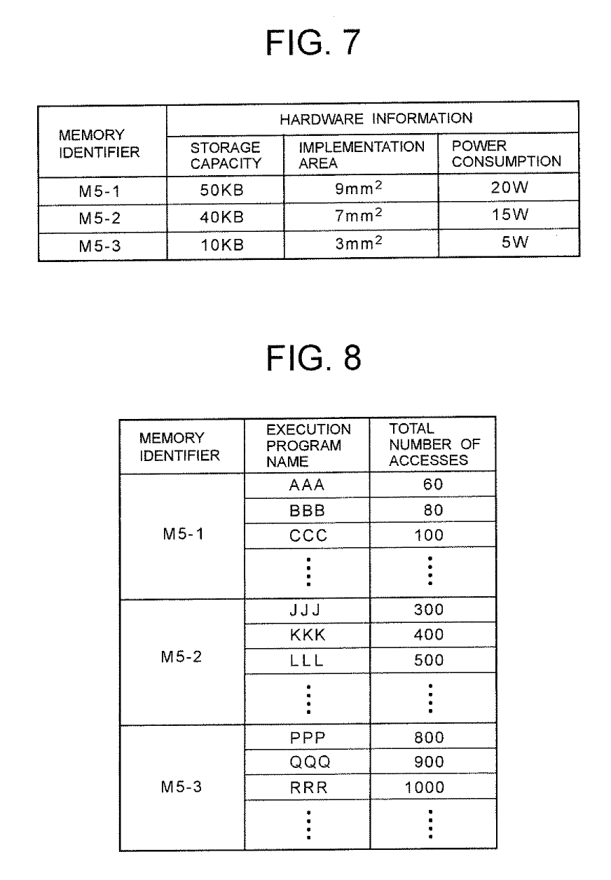

FIG. 7 is a diagram showing an example of a database of the hardware information in the internal program memory. M5-1, M5-2 and M5-3 shown in “Memory Identifier” refer to an identifier to identify the ordinary internal program memories 5-1 and 5-2, and the small-capacity internal program memory 5-3, respectively. “Hardware information” is hardware information corresponding respectively to the ordinary internal program memories 5-1 and 5-2 and the small-capacity internal program memory 5-3, for example in this event, being divided into three items: storage capacity, packaging area and power consumption. Preferably, the microprocessor designing program outputs a memory configuration in such a form that a group of execution programs having a large total number of accesses given by the computation processing unit 2 corresponds to a memory identifier (here, M5-3 corresponding to the storage capacity of 10 KB) corresponding to a storage capacity smaller than the other storage capacity in said database.

FIG. 8 is a diagram showing an example of a memory configuration which the microprocessor designing program outputs according to the said database. M5-1, M5-2 and M5-3 shown in “Memory Identifier” refer to an identifier to identify the ordinary internal program memories 5-1 and 5-2 and the small-capacity internal program memory 5-3, respectively. “Execution Program Name” refers to the name of an execution program. “Total Number of Accesses” refers to a total number of accesses which the computation processing unit 2 makes to each of the execution programs. According to storage capacity information included in the hardware information database of each execution program, the microprocessor designing program outputs the execution programs PPP, QQQ and RRR which have a large total number of accesses, in correspondence with the memory identifier M5-3 which corresponds to relatively small storage capacity information (here, 10 KB). Specifically, the microprocessor designing program outputs the execution programs JJJ, KKK and LLL which have a total number of accesses smaller than the execution programs PPP, QQQ and RRR, in correspondence with the memory identifier M5-2 which corresponds to information of storage capacity larger than the memory identifier M5-3 (here, 40 KB). Likewise, the microprocessor designing program outputs the execution programs AAA, BBB and CCC which have a total number of accesses smaller than the execution programs JJJ, KKK and LLL in correspondence with the memory identifier M5-1 which corresponds to information of the storage capacity larger than the memory identifier M5-2 (here, 50 KB).

The above-described processing is an example where the microprocessor designing program enables the execution program to correspond to the memory identifier according to the storage capacity information. The microprocessor designing program may enable the execution program to correspond to a memory identifier based on packaging area and power consumption or combination thereof. Specifically, the database shown in FIG. 7 is an example, and the hardware information is not limited to the three items of storage capacity, packaging area and power consumption.

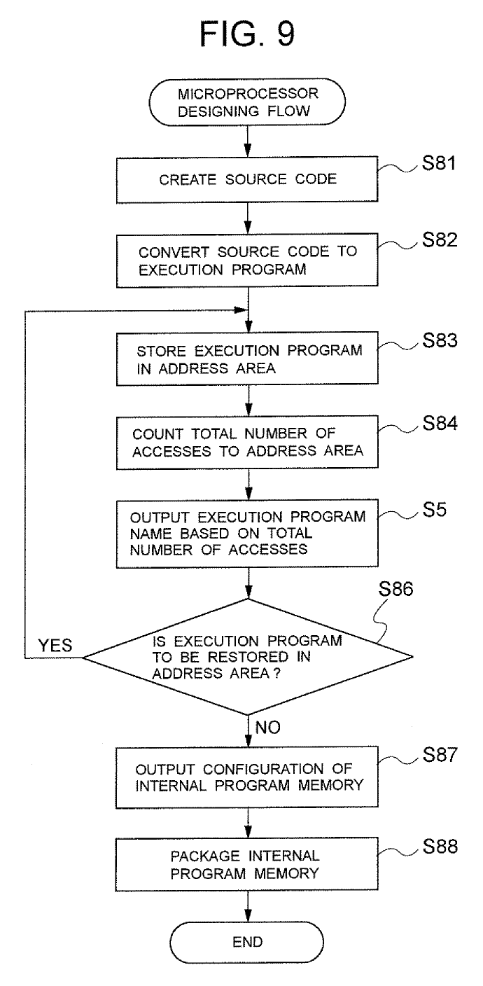

FIG. 9 is a flow chart showing an example of a designing flow of the microprocessor 1, including the output processing of the memory configuration. S81-S85 in the drawing are the same processing as that described above. Here, the microprocessor designing program by itself judges whether an execution program is restored or not in an address area, based on a result obtained by the access number totalizing step (S86). When the microprocessor designing program judges that the execution program is not restored, the memory configuration such as the quantity and storage capacity of the ordinary internal program memories 5-1 and 5-2 and the programming small-capacity memory 5-3 is determined and then outputted, based on the hardware information of the ordinary internal program memories 5-1 and 5-2 and small-capacity internal program memory 5-3 (S87). According to the outputted memory configuration, the designer of the microprocessor 1 can package the ordinary internal program memories 5-1 and 52 and the small-capacity internal program memory 5-3 in the microprocessor 1 (S88). In this event, as manpower required for a designer to review the memory configuration can be reduced, the microprocessor 1 can be designed at a shorter period of time.

As described above, according to the embodiments of the present invention, the computation processing unit counts the total number of accesses for each of the address areas, and outputs the execution program name in an order based on said total number. Further, based on the hardware information of the memory, the memory configuration such as quantity and storage capacity of the internal program memories can be outputted as well. From these outputted contents, the designer of the microprocessor 1 can confirm an execution program having a high execution frequency and desired memory configuration. When the designer specifies an address area so that an execution program having a high execution frequency is centered on a certain part of the memory area, each of the execution programs is stored in said specified address area by the execution program storing step. At this time, as the address area where the execution program having a high execution frequency is stored is integrated in part of the memory area, the execution programs stored in these address areas can be packaged as a whole in a internal program memory having small storage capacity. Thus, it is possible to reduce the quantity and storage capacity of the internal program memories which the computation processing unit accesses frequently, which permits to reduce the power consumed by the microprocessor. Specifically, as the designer can package the internal program memories based on the outputted memory configuration, the designer can reduce his own manpower to review the memory configuration, and design the microprocessor at a shorter period of time. Therefore, according to the embodiments of the present invention, it is possible to design a microprocessor which can be operated with low power consumption at a short period of time.

This application is based on Japanese Patent Application No. 2007-081469 which is hereby incorporated by reference.

What is claimed is:

1. A microprocessor designing program for designing a microprocessor including a memory having a plurality of address areas, and a computation processing unit for executing, by accessing any of said address areas, an instruction of an execution program stored in said address area accessed, comprising:
an execution program storing step of storing, as the address area is specified for each of said execution programs, each of said execution programs in said specified address area;
an access number totalizing step of counting the total number of accesses to be given to each of said address areas by said computation processing unit; and
an execution program name outputting step of outputting the name of said execution program in the order based on said total number.

2. A microprocessor designing apparatus comprising:
a controller in which a microprocessor designing program as set forth in claim 1 is installed; and
an execution program name displaying means for displaying, in characters, the name of the execution program outputted by said execution program name outputting step.

3. A microprocessor designing program according to claim 1, further comprising:
a database corresponding to information of a storage capacity for each of memory identifiers; and
a memory-by-memory execution program name outputting step of outputting a name, which corresponds to each of execution programs stored in each of said address areas large in said total number, in a manner to correspond to a memory identifier corresponding to a storage capacity smaller than those of the remaining storage capacities in said database, and a name, which corresponds to each of the execution programs stored in each of the address areas other than said address area having a large total number of accesses, in a manner to correspond to at least one memory identifier corresponding to the storage capacity larger than said smaller storage capacity.

4. A microprocessor designed by a microprocessor designing program as set forth in claim 1, comprising:
a small-capacity internal memory stored with an execution program stored in each of said address areas large in said total number; and
at least one ordinary internal memory stored with the execution program stored in each of the address areas other than the address areas large in said total number, and having a storage capacity larger than that of said small-capacity internal memory.

5. A microprocessor designing program according to claim 1,
wherein said execution program storing step stores each of said execution programs in the address areas of a virtual memory corresponding to said memory.
